(19) United States
(12) Patent Application Publication
(10) Pub. No.: US 2011/0234599 A1
(43) Pub. Date: Sep. 29, 2011

(54) SWING DISPLAY DEVICE AND METHOD

(75) Inventors: Kee Tong TAN, Singapore (SG); Khairullah Bin ZAYADI, Singapore (SG)

(73) Assignees: PANASONIC CORPORATION, Osaka (JP); PANASONIC SEMICONDUCTOR ASIA PTE. LTD., Singapore (SG)

(21) Appl. No.: 12/732,285

(22) Filed: Mar. 26, 2010

(51) Int. Cl. G09G 3/00; G06T 11/20

(52) U.S. Cl. 345/441; 345/31

(57) ABSTRACT

A swing display device includes a CPU which calculates and produces synchronizing signal relative to the length of the message to be displayed. Learning the speed of the synchronizing signal, the user swings the swing display device back-and-forth according to the synchronizing signal to produce the image in the air.

### BACKGROUND OF THE INVENTION

The present invention relates to a method of displaying images using the Persistence of Vision or POV method, and more particularly, to a swing display device and method. This is a common method of displaying images via switching light sources in a manner that utilizes the human vision's tendency to retain an image that appears just before another, such that continuous discrete displays of images are construed as a continuous motion or transformation of images. Examples of light sources that may be used include light emitting diodes (LEDs) and organic light emitting diodes (OLEDs).

A typical practical example of the swing display device employing the POV display is as shown in FIG. 1A. Using light sources placed on a display device, an image, for this case a letter ‘I’, may be displayed in mid-air. This is achieved by moving the display device from left to right and vice-versa continuously in a curved motion (in the current example of FIG. 1A) or in a straight line (as shown in FIG. 1B).

Referring to FIG. 1B, the image ‘I’ is broken down into 3 columns, i.e. columns C1, C2 and C3. Hence, as the display device moves in the forward display direction FD, column C1 will cause the corresponding light sources to light up first; followed by column C2 after a pre-determined delay time; followed by column C3 after a pre-determined delay time.

Various publications and patents describing POV displays and its applications have been disclosed, such as US2003/0100332 (“Luminescent Signaling Displays Utilizing a Wireless Mobile Communication Device”) and US2003/0080924 (“Kinetic Device and Method for Producing Visual Displays”).

An essential component in having a properly formed image during a POV display is by ensuring proper display timings of the said light sources through proper synchronizing systems. Typically, motion sensors such as inertia reversal sensors are used to detect the start and end of the POV swings, direction of swings, etc. The use of such sensors usually would increase the production cost to their products that incorporate such POV display capabilities.

Hence, a more cost-effective solution needs to be introduced; one that is able to implement the POV display, while at the same time does not cost more than is necessary. It is an object of the present invention to meet these needs, by introducing a simple implementation of synchronizing swings and light sources to produce the POV image display, while potentially costing less than conventional systems.

### SUMMARY OF THE INVENTION

The purpose of this invention is to provide a system to implement the POV display while at the same time does not cost more than is necessary.

According to the present invention, a swing display device for displaying a message image while swinging the swing display device back-and-forth in the air, comprises: a display image input operable to generate an image data representing the message image for display; a CPU operable to calculate a message image producing time for producing the message image during one swing of the swing display device, operable to divide the message image into a plurality of line segments which are sequentially produced with a calculated time interval, and operable to generate a first marginal time before the occurrence of the message image and a second marginal time after the occurrence of the message image; a timer operable to count a single swing time including the first marginal time, the message image producing time, and the second marginal time, and to produce a synchronizing signal after every single swing time; a timing indicator operable to produce a sign in response to the synchronizing signal; an array of light sources aligned vertically; and a controller operable to control the array of light sources to turn on and off the light sources in response to the information of said message image contained in one line segment.

### BRIEF DESCRIPTION OF THE DRAWINGS

FIG. 1A is an example of POV display according to the prior art.

FIG. 1B is another example of POV display according to the prior art.

FIG. 2 is a block diagram of a swing display device based on a first embodiment of the present invention.

FIG. 3 is a perspective view of a swing display device based on the present invention.

FIG. 4A is a flow chart showing a swing display method according to present invention.

FIG. 4B is a flow chart showing a detail of a display sequence of the swing display method based on present invention.

FIG. 5 is a diagram showing an operating sequence of a swing display device based on present invention.

FIG. 6 is a block diagram of swing display device based on a second embodiment of the present invention.

FIG. 7 is a block diagram of swing display device based on a third embodiment of the present invention.

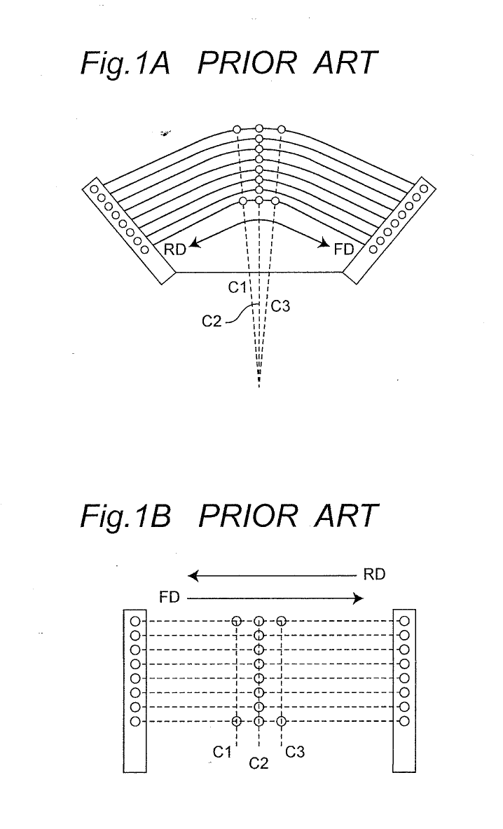

It will be recognized that some or all of the Figures are schematic representations for purposes of illustration and do not necessarily depict the actual relative sizes or locations of the elements shown.

### DETAILED DESCRIPTION OF THE PREFERRED EMBODIMENTS

### First Embodiment

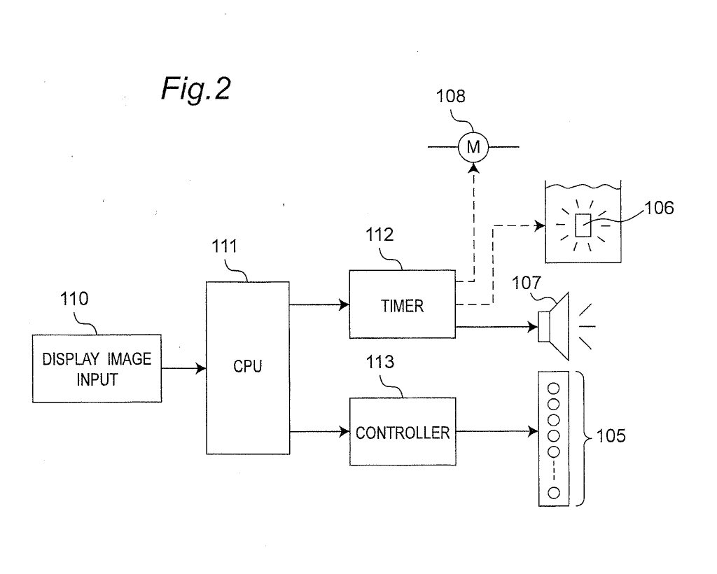

Referring to FIG. 2, a swing display device according to a first embodiment of the present invention is shown. The swing display device has a display image input 110, a CPU 111, a timer 112, a controller 113 and an array of light sources 105 aligned in a line. Furthermore, a timing indicator is provided, which can be at least one of a light source indicator 106, an audible sound generator 107, and a vibrator 108.

The swing display device of the present invention can be formed as a stick type device only for the swing display purpose, but can be built in an existing device, such as a mobile phone, a fan, a toy, or any other unit. The description herein is particularly directed to the swing display device built in a mobile phone, as an example.

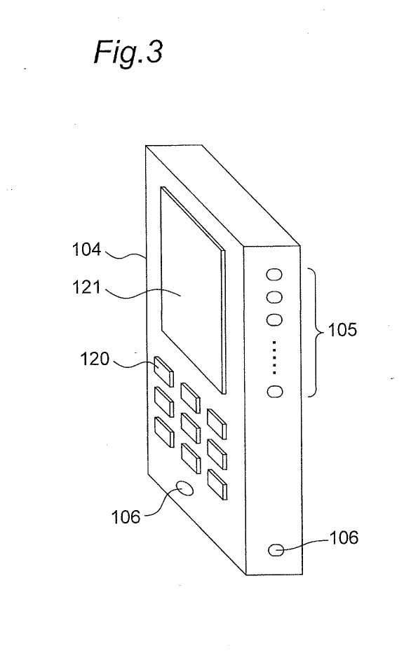

Referring to FIG. 3, a mobile phone 104 is shown with a built in swing display device of the present invention. The mobile phone 104 has input keys 120, a display panel 121, the array of light sources 105, and at least one light source indicator 106 (there are two indicators shown in FIG. 3). The light source indicator 106 may be located in line with the linear array of light sources 105. The sound generator 107 and the vibrator 108 are also incorporated in the mobile phone 104.

The timing indicator, such as the light source indicator 106, is provided for producing a human sensible sign in response to the synchronizing signal, such as a sound signal, light signal or vibration signal. The synchronizing signal represents the swinging speed of the swing display device, in this case, the mobile phone 104. The light source indicator 106 produces a series of blinks in a calculated speed. The user swings the mobile phone back-and-forth facing the light source array 105 front, in synchronization with the tempo of the blinks such that the user swings the mobile phone in one direction and returns the mobile phone in the opposite direction in synchronization to the blink. If the blinking speed is fast, the swing speed should be fast in synchronization with the blinking speed.

Instead of the blinking light, the user may use beeping sound or any appropriate audible indicator as a synchronizing signal. In another example, instead of the blinking light, the user may use a short vibration as a synchronizing signal.

Next, the synchronizing signal is described in detail.

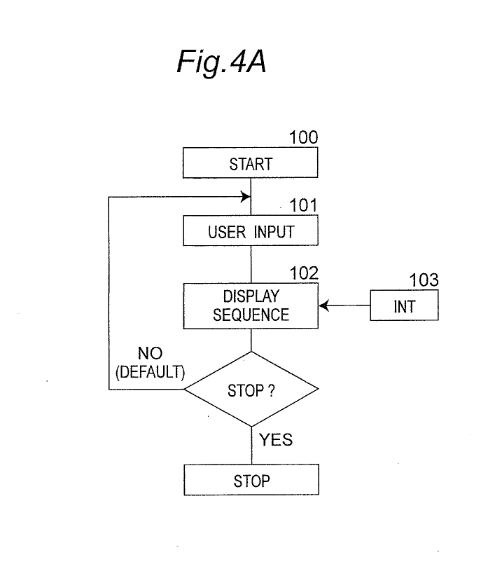

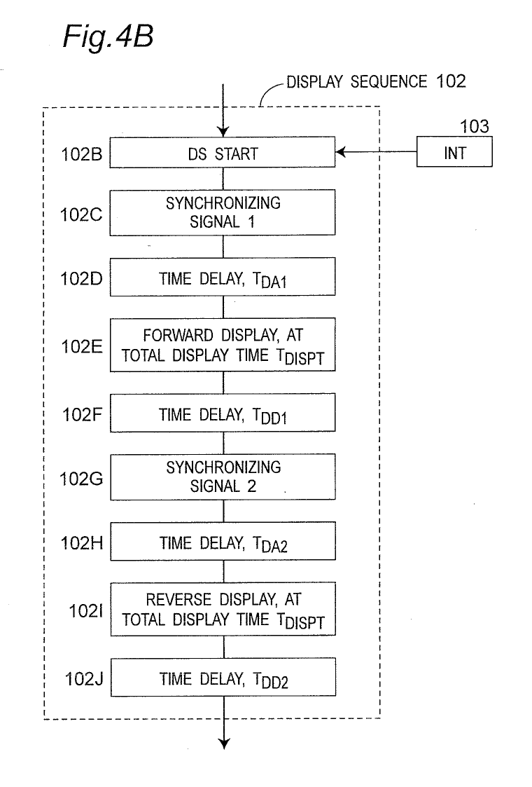

Referring to FIGS. 4A and 4B, operation of the swing display device according to the present invention is described, particularly describing the steps for producing the synchronizing signal.

At step 100, the swing display device is initiated.

At step 101, the user inputs a message, such as a character, a sentence, or any other image such as a smile face image, using the keys 120 in the device 104. According to a preferable embodiment, the message input can be accomplished via a suitable Graphical User Interface (GUI) or even direct typing by the user. It is assumed here that a character “I” is inputted as a message.

At step 102, the display sequence is carried out. During the display sequence, the device 104 produces a series of synchronizing signals at a calculated frequency.

Upon completion of display sequence 102, step 101 of user input can be repeated, when the user selects a new input to display.

Alternatively, the user may change the input to display while the display sequence is still being run. Through interrupt instruction INT 103, via a suitable Graphical User Interface (GUI) or even direct typing by the user, the display sequence 102 may re-start.

The user can end the display, for example by pressing a mechanical stop button or via a software GUI.

Referring to FIG. 4B, a detail of the display sequence 102 is shown.

At step 102B, the display sequence (DS) starts.

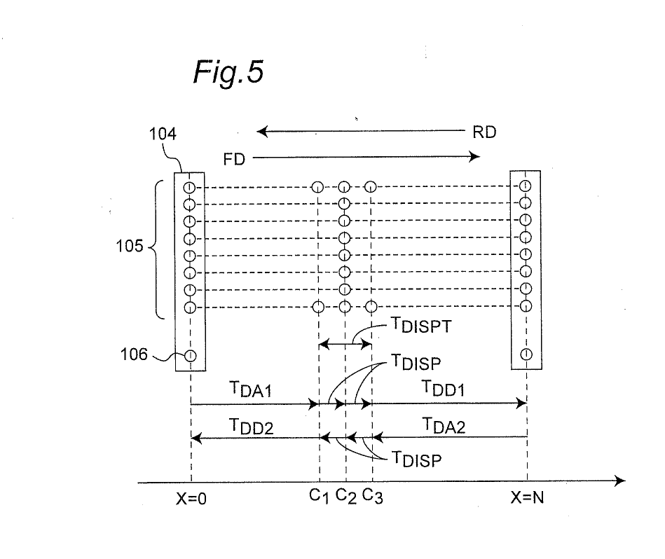

At step 102C, a synchronizing signal 1 is produced. In response to the synchronizing signal 1, the user swings the swing display device 4 in a forward direction FD, as shown in FIG. 5.

As shown in FIG. 5, the swing display device 104 is swung by a user between two extreme ends which are denoted by positions x=0 and x=N, where both points are relative to each other. Thus, when the synchronizing signal 1 is produced, the swing display device 104 should be located at position x=0, being ready to be swung in the forward direction FD.

At step 102D, time delay TDA1 is counted. The time delay TDA1 is a period of time to accelerate the swing display device 104 to a pre-selected speed. In FIG. 5, during time delay TDA1, the swing display device 104 is moved from position x=0 to position C1. The time delay TDA1 is a marginal time which can be a pre-fixed time, or can be obtained by a calculation.

At step 102E, a total display time TDISPT is calculated and counted. As shown in FIG. 5, during the total display time TDISPT the message is displayed from the very beginning edge to the very end edge. Thus, the total display time TDISPT is a message image producing time. The longitudinal image of the message is sliced into vertical line segments. In the case of character “I”, the character “I” itself is sliced into three line segments C1, C2 and C3 as shown in FIG. 5. The three line segments are sequentially produced and activated in said forward sequence. At line segment C1, top and bottom light sources in the array 105 are illuminated. At line segment C2, all the light sources in the array 105 are illuminated. At line segment C3, top and bottom light sources in the array 105 are illuminated. When these three line segments C1, C2 and C3 are activated in said forward sequence and are viewed together, a character “I” will appear in the swung course of swing display device 104. As shown in FIG. 5, a time interval provided between two adjacent line segments, such as between C1 and C2, is TDISP. A drive pulse for activating the light source array 105 is produced at the beginning of each line segments C1, C2 and C3, and can be a very thin pulse compared to the time interval TDISP. The width of the drive pulse, or the amplitude of the drive pulse, can be adjusted to enhance the appearance of the character.

The total display time TDISPT can be expressed as follows.

TDISPT=(CT−1)×TDISP

wherein CT is a number of line segments used for displaying the message. In the case of character “I”, the total display time TDISPT is equal to 2*TDISP, as apparent from FIG. 5.

At step 102F, time delay TDD1 is counted. The time delay TDD1 is a period of time to decelerate the swing display device 104 to zero, i.e., to complete stop. In FIG. 5, during time delay TDD1, the swing display device 104 is moved from the position of line segment C3 to position x=N. The time delay TDD1 is a marginal time which can be a pre-fixed time, or can be obtained by a calculation.

At step 102G, a synchronizing signal 2 is produced. In response to the synchronizing signal 2, the user swings the swing display device 4 in a reverse direction RD, as shown in FIG. 5. A time between the synchronizing signal 1 and the synchronizing signal 2 is a single swing time including the marginal time TDA1, the message image producing time TDISPT, and the marginal time TDD1.

At step 102H, time delay TDA2 is counted. The time delay TDA2 is a period of time to accelerate the swing display device 104 to a pre-selected speed. In FIG. 5, during time delay TDA1, the swing display device 104 is moved from position x=N to position C3. The time delay TDA2 is a marginal time which can be a pre-fixed time, or can be obtained by a calculation.

At step 102I, a total display time TDISPT is counted again. During the total display time TDISPT the message is displayed from the very end edge to the very beginning edge. In the case of character “I”, three line segments C3, C2 and C1 as shown in FIG. 5, are produced and activated in said reverse sequence. When these three line segments C3, C2 and C1 are activated in said reverse sequence and are viewed together, a character “I” will appear in the swung course of swing display device 104 in an overlap manner with respect to the character “I” produced in step 102E.

At step 102J, time delay TDD2 is counted. The time delay TDD2 is a period of time to decelerate the swing display device 104 to zero, i.e., to complete stop. In FIG. 5, during time delay TDD2, the swing display device 104 is moved from the position of line segment C1 to position x=0. The time delay TDD2 is a marginal time which can be a pre-fixed time, or can be obtained by a calculation.

According to a preferred embodiment, TDA1=TDD2, and TDD1=TDA2. Thus, the synchronizing signals 1 and 2, generally referred to as synchronizing signals, are produced alternately at a calculated frequency.

The above steps are carried out in the embodiment shown in FIG. 2 as follows.

At step 102B, display image input 110 receives the image data selected by the user. This is achievable, for example, via a suitable Graphical User Interface (GUI) designed for this purpose, by user typing, and other means.

The request to display the selected image will be communicated to a CPU. This CPU may be the CPU already present in a mobile phone (for cases of POV display on a mobile phone), or a stand-alone CPU (for cases of display devices with no CPUs present). The CPU processes the request sent by display image input 110 and calculates a single swing time. Subsequently, CPU 111 will communicate with timer 112 to cause light source indicator 106 to blink at least once to indicate the two extreme ends for the motion of the display device 104, which is an exemplary implementation of the synchronizing signals 1 and 2 (step 102C and 102G).

An alternative means to provide the synchronizing signal 1 would be to use audible sound generator 107, where the timer 112 will cause it to generate a sound (for example, to beep at least once).

Yet another alternate means would be for display device 104 to incorporate both light source indicator 106 and audible sound generator 107, thus both indications by the light source indicator 106 and audible sound generator 107 will be generated.

Yet another alternate means to provide the synchronizing signals 1 and 2 would be to use the vibrating means 108, for example, in the form of a vibration motor.

Yet another alternative means would be to use the vibrating means in tandem with the light source indicator 106 or audible sound generator 107.

The CPU 111 will also communicate with the controller 113 to cause the linear array of light sources 105 to light up according to the forward display step 102E and reverse display step 102I at TDISP intervals. An example of the controller 113 would be a Light Management Unit integrated circuit.

The calculated frequency of the synchronizing signal depends on the length of the message, such that when the message becomes long, the calculated frequency becomes low. In actual use, the user first learns, for example by listening to the beeping sound, the speed of the synchronizing signals. Then, the user swings the swing display device 104 in synchronization with the synchronizing signals. In this manner, the message can be produced in an overlap manner between the image produced during the swing of the forward direction FD and that produced during the swing of the reverse direction RD.

### Second Embodiment

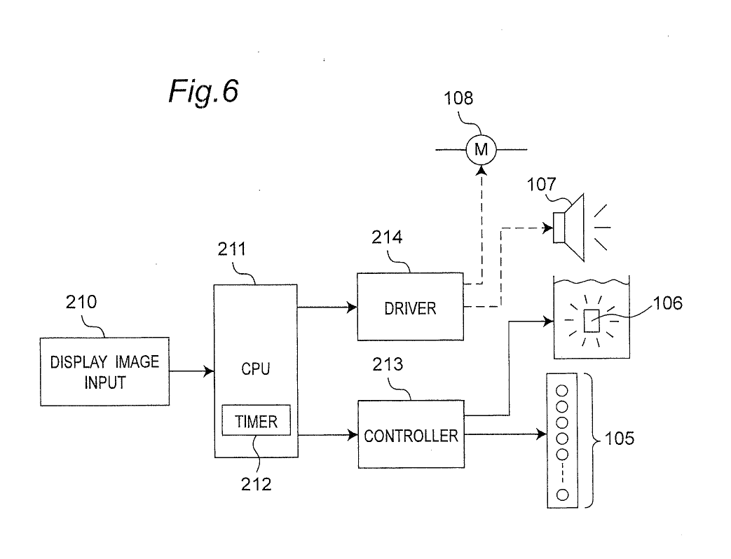

Referring to FIG. 6, a second embodiment of an exemplary system implementation to realize the sequence of implementation of the POV-type display by the swing display device based on the present invention is shown.

Based on the second embodiment, the system comprises the following components: display image input 210, CPU 211, timer 212, light source indicator 106 (or audible sound generator 107 and vibrating means 108), controller 213 and an array of light sources 105.

The second embodiment works the same way as the previous embodiment. Hence, the full operation description will not be described here. Instead, the differences between the two embodiments will be described.

One difference between the second embodiment and the first embodiment is that the timer 212, internal to CPU 211, is used for all timing operations. Also, a driver block 214 is introduced to provide a drive signal with sufficient power to the audible sound generator 107 and vibrating means 108, for optional cases where the user wishes to use the audible sound generator 107 or vibrating means 108, in tandem or otherwise. Also, the controller 213 now would drive the array of light sources 105 and light source indicator 106.

### Third Embodiment

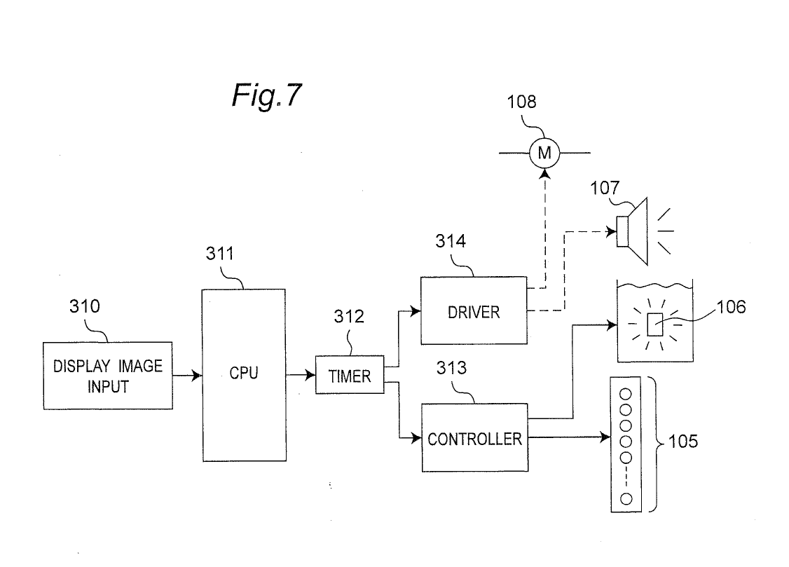

Referring to FIG. 7, a third embodiment of an exemplary system implementation to realize the sequence of implementation of the POV-type display by the swing display device based on the present invention is shown.

Based on the second embodiment, the system comprises the following components: display image input 310, CPU 311, timer 312, light source indicator 106 (or audible sound generator 107 and vibrating means 108), controller 313 and an array of light sources 105.

The third embodiment works the same way as the first embodiment. Hence, the full operation description will not be described here. Instead, the differences between the third and the first embodiments will be described.

One difference between the third embodiment and the first embodiment is that a common timer 312 that is external to the CPU is used for all timing operations. Also, a driver block 314 is introduced to provide a drive signal with sufficient power to the audible sound generator 107 and vibrating means 108, for optional cases where the user wishes to use the audible sound generator 107 or vibrating means 108, in tandem or otherwise.

What is claimed is:

1. A swing display device for displaying a message image while swinging the swing display device back-and-forth in the air, the device comprising:
a display image input operable to generate an image data representing the message image for display;
a CPU operable to calculate a message image producing time for producing the message image during one swing of the swing display device, operable to divide the message image into a plurality of line segments which are sequentially produced with a calculated time interval, and operable to generate a first marginal time before the occurrence of the message image and a second marginal time after the occurrence of the message image;
a timer operable to count a single swing time including the first marginal time, the message image producing time, and the second marginal time, and to produce a synchronizing signal after every single swing time;
a timing indicator operable to produce a sign in response to the synchronizing signal;
an array of light sources aligned vertically; and
a controller operable to control the array of light sources to turn on and off the light sources in response to the information of said message image contained in one line segment.

2. The device according to claim 1, wherein said timer is internal to the CPU.

3. The device according to claim 1, wherein said timing indicator comprises a light emitting diode.

4. The device according to claim 1, wherein said timing indicator comprises an audible sound generator.

5. The device according to claim 1, wherein said timing indicator comprises a vibration motor.

6. The device according to claim 4, further comprising a driver operable to provide a driving power to the audible sound generator.

7. The device according to claim 5, further comprising a driver operable to provide a driving power to the vibration motor.

8. The device according to claim 3, wherein said light emitting diode is controlled by said controller.

9. The device according to claim 8, wherein said controller is a light management unit integrated circuit.

10. The device according to claim 1, wherein said timer is external to the CPU, and further controls the timing of the timing indicator and the array of light sources.

11. The device according to claim 10, wherein said timing indicator comprises a light emitting diode.

12. The device according to claim 10, wherein said timing indicator comprises an audible sound generator.

13. The device according to claim 10, wherein said timing indicator comprises a vibration motor.

14. The device according to claim 12, further comprising a driver operable to provide a driving power to the audible sound generator.

15. The device according to claim 13, further comprising a driver operable to provide a driving power to the vibration motor.

16. The device according to claim 11, wherein said light emitting diode is controlled by the said controller.

17. The device according to claim 16, wherein said controller is a light management unit integrated circuit.

18. A swing display method for displaying a message image while swinging a swing display device back-and-forth in the air, the method comprising:
generating by a display image input an image data representing the message image for display;
calculating by a CPU a message image producing time for producing the message image during one swing of the swing display device;
dividing by the CPU the message image into a plurality of line segments which are sequentially produced with a calculated time interval;
generating by the CPU a first marginal time before the occurrence of the message image and a second marginal time after the occurrence of the message image;
counting by a timer a single swing time including the first marginal time, the message image producing time, and the second marginal time, and producing a synchronizing signal after every single swing time;
producing by a timing indicator a sign in response to the synchronizing signal;
controlling by a controller an array of light sources aligned vertically so as to turn on and off the light sources in response to the information of said message image contained in one line segment.

19. The method according to claim 18, further comprising:
receiving a new image to be displayed.

20. The method according to claim 19, further comprising:
interrupting the control of the array of light sources;
carrying out the steps of calculating, dividing and generating by said CPU for the new image; and
re-starting the control of the array of light sources for displaying the new image.

21. The method according to claim 18, wherein the swing display device is swung in a forward direction and in a reverse direction, alternately, and wherein said line segments are activated sequentially in forward order during the forward direction swing, and in reverse order during the reverse direction swing.

22. The method according to claim 18, wherein said light sources are light emitting diodes (LEDs).

23. The method according to claim 18, wherein said light sources are organic light emitting diodes (OLEDs).
